(19) United States
(12) Patent Application Publication
(10) Pub. No.: US 2023/0306854 A1
(43) Pub. Date: Sep. 28, 2023

(54) INFORMATION PROCESSING DEVICE AND INFORMATION PROCESSING METHOD

(71) Applicant: KDDI CORPORATION, Tokyo (JP)

(72) Inventors: Sou YAMAZAKI, Tokyo (JP); Hiroshi KAWANA, Tokyo (JP)

(73) Assignee: KDDI CORPORATION, Tokyo (JP)

(21) Appl. No.: 18/104,435

(22) Filed: Feb. 1, 2023

(30) Foreign Application Priority Data
Mar. 28, 2022 (JP) 2022-051929

(51) Int. Cl. G08G 5/00

(52) U.S. Cl. CPC G08G 5/003; G08G 5/006

(57) ABSTRACT

An operation plan management device includes a storage unit that associates and stores notification destination information indicating a notification destination of a manager, and area information indicating; a specifying unit that, upon acquiring operation plan information including a flight device ID of a flight device scheduled to fly, scheduled operation date and time information, and movement range information indicating the scheduled operation range, specifies the notification destination information in association with the area at least partially overlapping with the scheduled operation range indicated by the movement range information included in the operation plan information; and a notification unit that notifies the notification destination indicated by the specified notification destination information of plan notification information, which is at least one of at least partial information included in the acquired operation plan information and first access destination information for accessing that partial information.

### CROSS REFERENCE TO RELATED APPLICATION

Priority is claimed on Japanese Patent Application No. 2022-051929, filed Mar. 28, 2022, the content of which is incorporated herein by reference.

### BACKGROUND OF THE INVENTION

### Field of the Invention

The present invention relates to an information processing device and an information processing method.

### Description of Related Art

Conventionally, there is known an operation plan management system that manages the operation plan of a flight device that is an unmanned aircraft system (UAS) such as a drone (see, for example, PCT International Publication No. 2019/012713).

In the operation plan management system, UASSPs (UAS Service Providers), which are multiple service providers, receive operation plan information indicating operation plans from planners who plan operation plans of flight devices, and inform other UASSPs of the operation plan information.

### SUMMARY OF THE INVENTION

Accordingly, an example of the object of the present invention is to efficiently provide notification of operation plan information.

An information processing device according to the first aspect of the present invention includes: a storage unit that associates and stores notification destination information indicating a notification destination of a manager who manages an operation of a flight device, and area information indicating an area managed by the manager; a plan information acquisition unit that acquires operation plan information including flight device identification information for identifying a flight device scheduled to fly, scheduled operation date and time information indicating a date and time when the flight device is scheduled to fly, and movement range information indicating a scheduled operation range in which the flight device is scheduled to fly; a specifying unit that specifies the notification destination information stored in the storage unit in association with the area at least partially overlapping with the scheduled operation range indicated by the movement range information included in the operation plan information acquired by the plan information acquisition unit; and a notification unit that notifies the notification destination indicated by the notification destination information specified by the specifying unit of plan notification information, which is at least one of at least partial information included in the operation plan information acquired by the plan information acquisition unit and first access destination information for accessing that partial information.

The information processing device may further include an operation information acquisition unit that acquires operation information including the flight device identification information corresponding to the flight device and flight position information indicating the current flight position of the flight device from the flight device that flew based on the operation plan information acquired by the plan information acquisition unit, and the notification unit may notify the notification destination indicated by the notification destination information specified by the specifying unit of operation status notification information, which is at least one of the operation information acquired by the operation information acquisition unit and second access destination information for accessing the operation information.

The storage unit may associate and store the notification destination information and notification necessity information indicating whether or not notification of the operation information to the notification destination indicated by the notification destination information is required, and the notification unit may provide notification of the operation status notification information when the notification necessity information stored in the storage unit associated with the notification destination information specified by the specifying unit indicates that notification of the operation information is required.

The storage unit may associate and store the notification destination information and time period information indicating a time period in which notification of the operation information to the notification destination indicated by the notification destination information is required, and the notification unit may provide notification of the operation status notification information when the time at which the operation information acquisition unit has acquired the operation information is included in the time period indicated by the time period information stored in the storage unit in association with the notification destination information specified by the specifying unit.

The storage unit may associate and store the notification destination information and specific area information indicating a specific area, included in the area, that requires notification of the operation information to the notification destination indicated by the notification destination information, and the notification unit may provide notification of the operation status notification information when the flight position information included in the operation information acquired by the operation information acquisition unit is included in the specific area indicated by the specific area information associated with the notification destination information specified by the specifying unit.

The notification unit may specify the number of pieces of the operation plan information managed by the manager corresponding to the notification destination information specified by the specifying unit, determine whether to provide notification of the plan notification information on the basis of the number of number of pieces of operation plan information specified, and provide notification of the plan notification information upon determining to provide notification of the plan notification information.

The notification unit may determine whether or not to provide notification of the plan notification information on the basis of the number of pieces of the operation plan information of another flight device scheduled to fly at the time when the flight device indicated by the operation plan information acquired by the plan information acquisition unit is scheduled to fly, the operation plan information being managed by the manager corresponding to the notification destination information specified by the specifying unit.

The notification unit may notify the notification destination indicated by the notification destination information specified by the specifying unit of the plan notification information including at least one of the movement range information including the area corresponding to the notification destination and an area different from that area, included in the operation plan information acquired by the plan information acquisition unit, and the first access destination information for accessing the movement range information.

The specifying unit may specify a plurality of the pieces of notification destination information stored in the storage unit in association with a plurality of the areas at least partially overlapping with the scheduled operation range indicated by the movement range information included in the operation plan information acquired by the plan information acquisition unit, and the notification unit may notify the plurality of notification destinations indicated by each of the plurality of pieces of notification destination information specified by the specifying unit of the plan notification information.

The specifying unit may specify one or more pieces of notification destination information stored in the storage unit in association with the area at least partially overlapping with the scheduled operation range indicated by the movement range information included in the operation plan information acquired by the plan information acquisition unit, and the notification unit may notify the notification destination indicated by each of the plurality of pieces of the notification destination information when the specifying unit has specified a plurality of pieces of the notification destination information.

The information processing device according to the second aspect of the present invention is an information processing device used by a manager who manages an operation of a flight device, the information processing device including: a storage unit that stores notification destination information indicating a notification destination of another manager who manages the operation of another flight device not managed by the manager in an area in which the manager manages the operation of the flight device; a plan information acquisition unit that acquires operation plan information indicating an operation plan to be managed by the manager, which is the operation plan of the flight device scheduled to fly in the area; and a notification unit that, when the plan information acquisition unit acquires operation plan information, notifies the notification destination indicated by the notification destination information stored in the storage unit of plan notification information, which is at least one of at least partial information included in the operation plan information acquired by the plan information acquisition unit and first access destination information for accessing that partial information.

An information processing method, executed by a computer, according to the third aspect of the present invention including: acquiring operation plan information including flight device identification information for identifying a flight device scheduled to fly, scheduled operation date and time information indicating a date and time when the flight device is scheduled to fly, and movement range information indicating a scheduled operation range in which the flight device is scheduled to fly; referring to a storage unit that associates and stores notification destination information indicating a notification destination of a manager who manages an operation of the flight device and area information indicating an area managed by the manager to specify the notification destination information associated with the area at least partially overlapping with the scheduled operation range indicated by the movement range information included in the acquired operation plan information; and notifying the notification destination indicated by the specified notification destination information of plan notification information, which is at least one of at least partial information included in the acquired operation plan information and first access destination information for accessing that partial information.

### BRIEF DESCRIPTION OF THE DRAWINGS

FIG. 1 is a diagram showing an overview of the operation plan management system.

FIG. 2 is a diagram showing a functional configuration of the operation plan management device.

FIG. 3 is a diagram showing an example of notification destination management information.

FIG. 4 is a diagram showing an example of operation plan information.

FIG. 5 is a diagram showing an example of notification destination management information including notification necessity information.

FIG. 6 is a diagram showing an example of notification destination management information including time period information.

FIG. 7 is a diagram showing an example of notification destination management information including specific area information.

FIG. 8 is a flowchart showing the flow of processing in the operation plan management device.

### DETAILED DESCRIPTION OF THE INVENTION

### [Overview of Operation Plan Management System S]

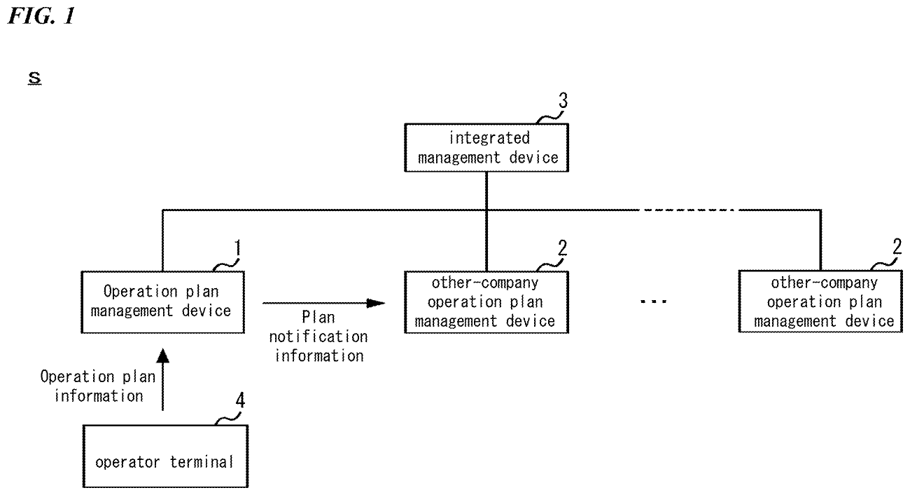

FIG. 1 is a diagram showing an overview of the operation plan management system S. The operation plan management system S is a system that manages the operation plan of a flight device that is an unmanned aerial vehicle such as a drone.

The operation plan management system S is provided with an operation plan management device 1, other-company operation plan management devices 2, an integrated management device 3, and an operator terminal 4. The operation plan management device 1 is an information processing device communicably connected to the other-company operation plan management devices 2, the integrated management device 3, and the operator terminal 4 via a wired or wireless communication network.

The operation plan management device 1 is, for example, a computer operated by an Unmanned Aircraft Systems Service Provider (UASSP) as an operation manager managing the operations of flight devices flying in a predetermined area.

The operation manager is, for example, a predetermined telecommunications carrier that provides a wireless communication line such as a mobile phone line that can be used in a predetermined area. The operation plan management device 1 manages operations of flight devices that fly over a predetermined area using a wireless communication line provided by the predetermined telecommunications carrier.

The other-company operation plan management devices 2 are computers operated by other operation managers (UASSPs) that respectively manage the operations of flight devices flying in other areas that at least partially overlap with the predetermined area.

The other operation managers are, for example, other carriers that provide wireless communication lines available in other areas. Each of the plurality of other-company operation plan management devices 2 manage operation plans of flight devices that fly using wireless communication lines provided by the other operation managers.

The integrated management device 3 is computer that functions as a FIMS (Flight Information Management System) or DIPS (Drone/UAS Information Platform System) that integrates and manages operation plan information managed by the operation plan management device 1 and the plurality of other-company operation plan management devices 2, respectively. The operator terminal 4 is a terminal used by an operator of a flight device (Unmanned Aircraft System Operator: UASO), and is, for example, a computer such as a personal computer, a smart phone, or a tablet. The operator terminal 4 is used to apply for an operation plan to the operation plan management device 1.

The operation plan management device 1 acquires from the operator terminal 4 operation plan information including a flight device ID that is flight device identification information for identifying the flight device that is scheduled to fly, scheduled operation date and time information that indicates the date and time that the flight device is scheduled to fly, and movement range information indicating the scheduled operation range that the flight device is scheduled to fly.

The operation plan management device 1 associates and stores notification destination information indicating the notification destination of the operation manager managing the operation of the flight device and area information indicating the area managed by the operation manager. The operation plan management device 1 specifies notification destination information stored in association with an area at least partially overlapping with the scheduled operation range of the flight device indicated by the acquired operation plan information.

The operation plan management device 1 notifies the notification destination indicated by the specified notification destination information of plan notification information, which is at least one of at least partial information included in the acquired operation plan information and access destination information for accessing that partial information. By doing so, since the operation plan management device 1 is able to provide notification of the plan notification information only to the operation manager that manages the area corresponding to the scheduled operation range in which the flight device corresponding to the acquired operation plan information is scheduled to fly, it is possible to perform efficient notification of the operation plan information.

Next, the configuration of the operation plan management device 1 will be described in detail. It is assumed that each of the other-company operation plan management devices 2 also has the same functions as the operation plan management device 1. Therefore, description of the functions of the other-company operation plan management device 2 is omitted.

### [Functional Configuration of Operation Plan Management Device 1]

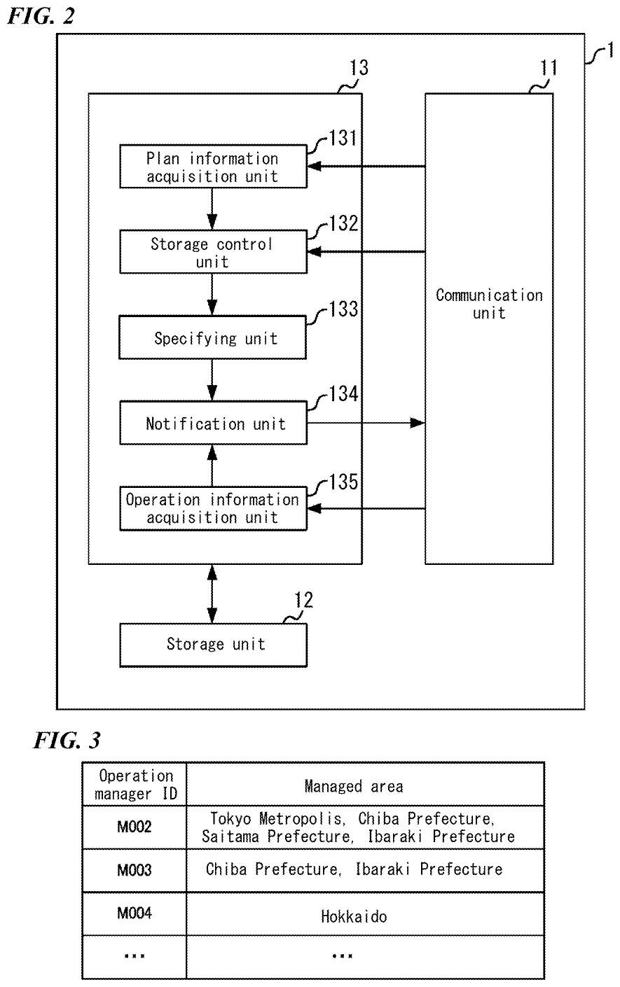

FIG. 2 is a diagram showing the functional configuration of the operation plan management device 1. The operation plan management device 1 has a communication unit 11, a storage unit 12 and a control unit 13.

The communication unit 11 is a communication interface for transmitting and receiving data to and from the other-company operation plan management device 2, the integrated management device 3, and the operator terminal 4 via a network such as the Internet.

The storage unit 12 is a storage medium that stores various types of data, and includes ROM (Read Only Memory), RAM (Random Access Memory), a hard disk, and the like. The storage unit 12 stores programs executed by the control unit 13. The storage unit 12 stores a program that causes the control unit 13 to function as a plan information acquisition unit 131, a storage control unit 132, a specifying unit 133, a notification unit 134, and an operation information acquisition unit 135.

The storage unit 12 stores notification destination management information in which notification destination information indicating the notification destination of the notification information of the operation manager managing an operation of a flight device and area information indicating the area managed by the manager are associated. FIG. 3 is a diagram showing an example of notification destination management information. The notification destination information is, for example, an operation manager ID for identifying the operation manager. By designating an operation manager ID as the notification destination of the notification information, it is possible to notify the operation manager corresponding to the operation manager ID of the notification information. Note that the notification destination information is not limited to the operation manager ID, and may be the mail address of the operation manager. The area information is, for example, information indicating an administrative division, such as a prefecture or municipality, indicating an area managed by an operation manager.

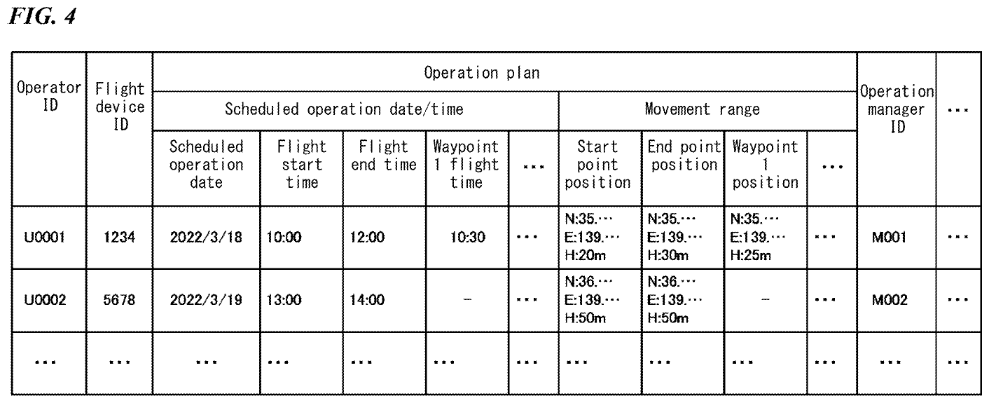

The storage unit 12 stores operation plan information acquired by the operation manager operating the operation plan management device 1 from the flight device operator or from another operation manager. FIG. 4 is a diagram showing an example of operation plan information. As shown in FIG. 4, the operation plan information is information in which the operator ID for identifying the operator of the flight device is scheduled to fly, a flight device ID for identifying the flight device, the operation plan of the flight device, and the operation manager ID are associated.

The operation plan includes, for example, scheduled operation date and time information indicating the date and time the flight device is scheduled to fly, and movement range information indicating the scheduled operation range in which the flight device is scheduled to fly. The scheduled operation date and time information includes the scheduled operation date on which the flight device is scheduled to fly, the flight start time that is the time to start the flight, the flight end time that is the time to end the flight, and flight times for each of one or more waypoints. The movement range information includes a start point position indicating the point at which the flight device starts flying, an end point position indicating the point at which flight ends, and the positions of one or more waypoints. The start point position, the end point position, and the positions of the waypoints include, for example, information indicating latitude, longitude, and altitude. Waypoint position is an item that can be arbitrarily registered by the operator, and does not have to be included in the operation plan information.

Note that the operation plan information may include an execution plan indicating operations to be executed by the flight device. The operations performed by the flight device are, for example, operations such as imaging, surveying, and equipment inspection. Also, although the movement range information includes the start point position, end point position, and waypoint positions, it is not limited thereto. When the flight device moves randomly in a three-dimensional space such as a cone or cube, the movement range information may define the three-dimensional space such as a cone or cube.

The operation manager ID included in the operation plan information indicates the entity managing the operation plan information. When the operation plan information is the operation plan information received from the operator terminal 4, and the operation manager who operates the operation plan management device 1 is the management entity of the operation plan information, the operation manager ID of the operation manager is associated with the operation plan information. When the operation plan information is the operation plan information received from the other-company operation plan management device 2, that is, when another operation manager who operates the other-company operation plan management device 2 is the management entity of the operation plan information, the operation manager ID of the other operation manager is associated with the operation plan information.

The control unit 13 is, for example, a CPU (Central Processing Unit). The control unit 13 functions as the plan information acquisition unit 131, the storage control unit 132, the specifying unit 133, the notification unit 134 and the operation information acquisition unit 135 by executing programs stored in the storage unit 12. Next, details of the plan information acquisition unit 131, the storage control unit 132, the specifying unit 133, the notification unit 134 and the operation information acquisition unit 135 will be described.

### [Acquisition of Operation Plan Information]

First, functions related to acquisition of operation plan information will be described. The plan information acquisition unit 131 acquires operation plan information including a flight device ID for identifying the flight device scheduled to fly, the operator ID of the operator of the flight device, scheduled operation date and time information indicating the date and time when the flight device is scheduled to fly, and movement range information indicating the scheduled operation range in which the flight device is scheduled to fly.

The plan information acquisition unit 131 receives the operation plan information from the operator terminal 4 or another operation manager who operates the other-company operation plan management device 2. Further, the plan information acquisition unit 131 stores the received operation plan information in the storage unit 12 upon receiving the operation plan information from another operation manager. The operation plan information received from another operation manager includes the operation manager ID of the other operation manager.

When the plan information acquisition unit 131 receives the operation plan information from the operator terminal 4, the storage control unit 132 sets the operation manager ID included in the operation plan information to the operation manager ID of the operation manager who operates the operation plan management device 1. The storage control unit 132 causes the storage unit 12 to store the operation plan information. In addition, the storage control unit 132 causes the storage unit 12 to store the operation plan information that the plan information acquisition unit 131 has received from other operation managers.

In addition, the storage control unit 132 causes the storage unit of the integrated management device 3 to store the operation plan information acquired by the plan information acquisition unit 131 from the operator terminal 4. Similarly to the operation plan management device 1, the other-company operation plan management device 2 stores operation plan information it has acquired from the operator terminal 4 in the storage unit of the integrated management device 3. As a result, the operation plan information acquired from the operator terminal 4 by each of the operation plan management device 1 and the plurality of other-company operation plan management devices 2 is collected in the storage unit 12 of the integrated management device 3.

### [Notification of Operation Plan Information]

Next, functions related to notification of operation plan information will be described. The specifying unit 133 specifies one or more pieces of notification destination information stored in the storage unit 12 in association with each of one or more areas at least partially overlapping with the scheduled operation range indicated by the movement range information included in the operation plan information acquired by the plan information acquisition unit 131.

Specifically, the specifying unit 133 specifies a scheduled operation route of the flight device indicated by the movement range information on the basis of the position of each of the start point position, the end point position, and one or more waypoints included in the movement range information included in the operation plan information that the plan information acquisition unit 131 acquired from the operator terminal 4. The specifying unit 133 specifies one or more administrative districts through which the flight device passes based on the specified scheduled operation route. The specifying unit 133, referring to the notification destination management information stored in the storage unit 12, specifies the operation manager ID as one or more pieces of notification destination information associated with the one or more administrative divisions that have been specified.

The notification unit 134 notifies one or more notification destinations respectively indicated by the one or more operation manager IDs specified by the specifying unit 133 of plan notification information, which is at least one of at least partial information included in the operation plan information acquired by the plan information acquisition unit 131 and first access destination information for accessing the partial information.

For example, the storage unit 12 stores the operation manager ID as notification destination information and the network address of each of the plurality of other-company operation plan management devices 2 in association with each other. The notification unit 134 transmits the plan notification information containing, as a message, at least one of the partial information included in the operation plan information acquired by the plan information acquisition unit 131 and a URL for accessing a page displaying the partial information using as the destination the network address of the other-company operation plan management device 2 associated with the operation manager ID specified by the specifying unit 133. As a result, the plan notification information is notified to the other-company operation plan management device 2, which is the notification destination corresponding to the operation manager ID.

In addition, when the notification destination information is an e-mail address, the notification unit 134 may provide notification of the plan notification information by transmitting an e-mail containing, as a message, the partial information included in the operation plan information or a URL for accessing a page displaying the partial information, with one or more e-mail addresses specified by the specifying unit 133 serving as destinations.

The partial information contained in the operation plan information notified by the plan notification information is the operator ID, the flight device ID, and partial scheduled flight positions and scheduled flight times included in the scheduled operation range and scheduled operation time. Partial scheduled flight positions are positions included in the area associated with the specified operation manager ID, among the positions of the start point position, end point position, and waypoints included in the scheduled operation range. Also, partial scheduled flight times are times when the flight device is scheduled to fly over the specified positions.

Although the case where the notification unit 134 uniformly transmits the plan notification information to the notification destination corresponding to the operation manager ID specified by the specifying unit 133 has been exemplified, the present invention is not limited thereto. For example, the notification unit 134 may specify the number of pieces of operation plan information managed by the operation manager corresponding to the operation manager ID specified by the specifying unit 133, and make a determination whether to provide notification of the plan notification information on the basis of the number of pieces of operation plan information specified.

In this case, the notification unit 134 specifies the operation plan information associated with the operation manager ID as the notification destination information specified by the specifying unit 133, among the plurality of pieces of operation plan information stored in the integrated management device 3, and specifies the number of pieces of operation plan information associated with the operation manager ID. Among the operation plan information managed by the notification destination indicated by the operation manager ID specified by the specifying unit 133, the notification unit 134 may specify operation plan information of another flight device scheduled to fly at the time when the flight device indicated by the operation plan information acquired by the plan information acquisition unit 131 is scheduled to fly, and specify the number of pieces of operation plan information specified.

The notification unit 134 makes a determination to provide notification of the plan notification information when the number of pieces of operation plan information that have been specified exceeds a predetermined threshold. The predetermined threshold may be set for each area, for each time, or for each area and time. Also, the predetermined threshold for each area may be set by a manager who manages the area. Then, upon determining to provide notification of the plan notification information, the notification unit 134 notifies the notification destination corresponding to the operation manager ID of the plan notification information. By doing so, when the number of operations of flight devices in an area managed by the notification destination corresponding to the operation manager ID is overcrowded, and it is necessary to take measures to prevent accidents such as collisions, the operation plan management device 1 can notify the notification destination of the plan notification information.

In addition, although the case was given where the notification unit 134 notifies the notification destination of the positions included in the area associated with the specified operation manager ID, among the start point position, end point position, and waypoint positions included in the scheduled operation range, and the scheduled time the flight device is schedule to pass each position, the present invention is not limited thereto. The notification unit 134 may notify the notification destination corresponding to the operation manager ID specified by the specifying unit 133 of the plan notification information including at least one of movement range information including the area corresponding to the notification destination and an area different from that area, included in the operation plan information acquired by the plan information acquisition unit 131, and first access destination information for accessing the movement range information.

Specifically, the notification unit 134 may notify the notification destination corresponding to the operation manager ID specified by the specifying unit 133 of all the movement range information and scheduled operation date and time information included in operation plan information acquired by the plan information acquisition unit 131 or the plan notification information indicating the scheduled operation route of the flight device indicated by all the movement range information and scheduled operation date and time information. By doing so, another operation manager operating the other-company operation plan management device 2 of the notification destination can ascertain the scheduled operation route of the flight device corresponding to the operation plan information received by the operation plan management device 1.

### [Notification of Operation Information]

Next, functions related to notification of operation information will be described. The operation information acquisition unit 135 acquires operation information including the flight device ID corresponding to the flight device and flight position information indicating the current flight position of the flight device from the flight device that flew based on the operation plan information acquired by the plan information acquisition unit 131. For example, the operation information acquisition unit 135 acquires operation information including the flight device ID and flight position information indicating the latitude, longitude, and altitude of the flight device from the flight device that flew based on the operation plan information acquired from the operator terminal 4 by the plan information acquisition unit 131. The storage control unit 132 stores the acquired operation information in the storage unit 12 as operation history information.

The notification unit 134 notifies the notification destination corresponding to the operation manager ID specified by the specifying unit 133 of operation status notification information, which is at least one of the operation information acquired by the operation information acquisition unit 135 and second access destination information for accessing the operation information.

For example, the notification unit 134 specifies an administrative district corresponding to the flight position of the flight device indicated by the flight position information included in the operation information acquired by the operation information acquisition unit 135. The notification unit 134 specifies one or more operation manager IDs associated with area information including the specified administrative district among the one or more operation manager IDs specified by the specifying unit 133.

For each of the one or more operation manager IDs that have been specified, the notification unit 134 transmits in real time, with the network address of the other-company operation plan management device 2 associated with the operation manager ID as a destination, operation status notification information including, as a message, at least one of the partial information included in the acquired operation information and a URL for accessing a page displaying the partial information. Thereby, the notification unit 134 notifies in real time the one or more notification destinations corresponding to the one or more operation manager IDs of the operation status notification information. By doing so, on the condition of the flight device that flew on the basis of the operation plan information having entered an area managed by a manager corresponding to the operation manager ID, the operation plan management device 1 can notify the manager of the operation information.

After notifying the notification destination corresponding to the specified operation manager ID of the operation status notification information, the notification unit 134 may determine whether or not the position indicated by operation information newly acquired by the operation information acquisition unit 135 has left the area corresponding to the administrative district associated with the operation manager ID. In response to determining that the position has left the area corresponding to the administrative district associated with the operation manager ID, the notification unit 134 may notify the notification destination indicated by the operation destination information of information indicating that the flight device has escaped from the area managed by the manager corresponding to the operation manager ID. By doing so, the operation plan management device 1 can make the manager corresponding to the operation manager ID recognize that the flight device has escaped from the area under his/her control.

In addition, the notification unit 134 may notify the notification destination corresponding to the operation manager ID of the operation status notification information including the actual flight route, which is the flight route of the flight device indicated by the plurality of pieces of operation information acquired by the operation information acquisition unit 135. For example, the notification unit 134 provides notice of operation status notification information including a map including lines indicating actual flight routes. In this case, the notification unit 134 may determine whether or not the flight position indicated by the actual flight route deviates from the flight position on the scheduled flight route indicated by the movement range information included in the operation plan information, and may display the actual flight route in a different display mode depending on whether the flight route is in line with the scheduled flight route or not. For example, the notification unit 134 may indicate, of the actual flight route, a partial route that does not deviate from the scheduled flight route and a partial route that does deviate from the scheduled flight route in different colors.

In addition, the notification unit 134 may provide notification of operation status notification information including one screen showing the actual flight route and the scheduled flight route. For example, the notification unit 134 may provide notification of the operation status notification information in which the actual flight route and the scheduled flight route are displayed in different colors on the map. By doing so, the operation plan management device 1 can allow the manager corresponding to the operation manager ID to ascertain whether the flight device is flying as scheduled.

Note that when giving notice of the operation status notification information including the URL for accessing a page that displays the partial information included in the operation information of the flight device, the notification unit 134 may give notice of the operation status notification information upon acquiring the operation information of the flight device for the first time, and may subsequently not provide notification of the operation status notification information even if operation information of the flight device is acquired.

Also, the case where the notification unit 134 uniformly transmits the operation status notification information to the notification destinations corresponding to the operation manager ID specified by the specifying unit 133 has been exemplified, but the present invention is not limited thereto. For example, the notification unit 134 may provide notification of the operation status notification information in response to the notification destination corresponding to the operation manager ID requesting notification of the operation status notification information.

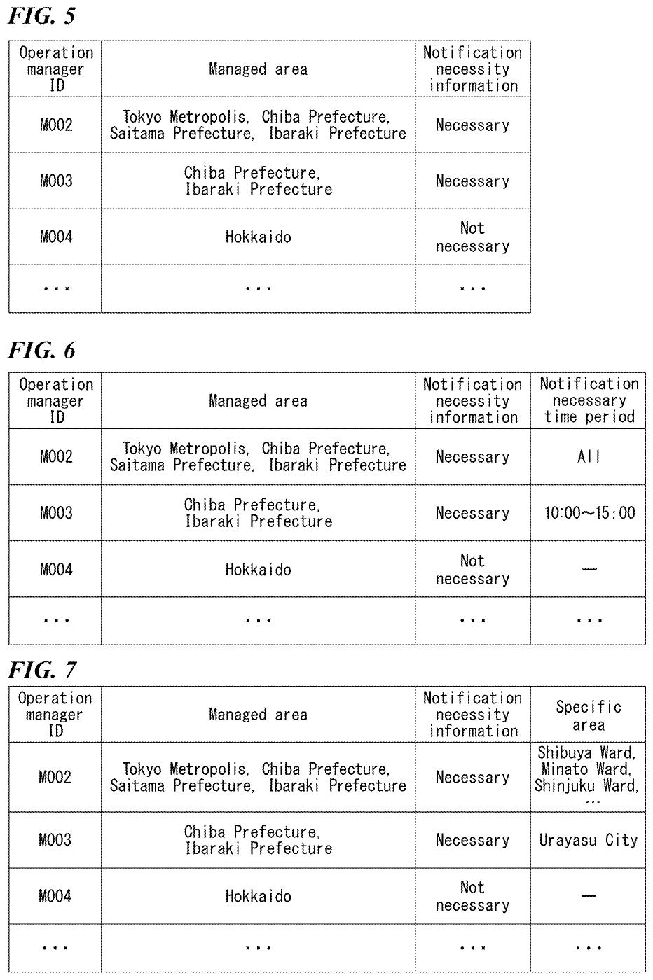

In this case, the storage unit 12 stores notification destination management information that associates the operation manager ID as the notification destination information and notification necessity information that indicates whether or not notification of operation information to the notification destination indicated by the operation manager ID is required. FIG. 5 is a diagram showing an example of notification destination management information including notification necessity information. In the example shown in FIG. 5, it can be confirmed that the notification necessity information indicating whether notification of the operation information is required is associated with the operation manager ID and area information. In the example shown in FIG. 5, when the notification necessity information is “necessary”, it indicates that the notification destination requires notification of the operation information, and when the notification necessity information is “unnecessary”, it indicates that the notification destination does not require notification of the operation information.

The notification unit 134 provides notification of the operation status notification information when the notification necessity information stored in the storage unit 12 associated with the operation manager ID specified by the specifying unit 133 is “necessary”, indicating that notification of the operation information is required. Further, the notification section 134 performs control so as to not provide notification of the operation status notification information when the notification necessity information stored in the storage unit 12 associated with the operation manager ID specified by the specifying unit 133 is “unnecessary”, indicating that notification of the operation information is not required. By doing so, the operation plan management device 1 can reduce the load related to the transmission of the operation status notification information.

In addition, although the case was exemplified in which the notification unit 134 transmits the operation status notification information on the condition that the notification destination corresponding to the operation manager ID specified by the specifying unit 133 desires the transmission of the operation status notification information, the present invention is not limited thereto. For example, the notification unit 134 may provide notification of the operation status notification information only during the time period in which the notification destination corresponding to the operation manager ID desires notification of the operation status notification information.

In this case, the storage unit 12 stores notification destination management information that associates the operation manager ID as the notification destination information and time period information indicating the time period during which notification of operation information to the notification destination indicated by the operation manager ID is required. FIG. 6 is a diagram showing an example of notification destination management information including time period information. In the example shown in FIG. 6, it can be seen that time period information indicating the time period during which notification of operation information to the notification destination is required is associated with the operation manager ID, area information, and notification necessity information. The time period indicated by the time period information is assumed to be some or all hours of a day, but is not limited thereto, and may be any time period corresponding to a day of the week, a national holiday, a day off, or a weekday.

If the time at which the operation information acquisition unit 135 acquires the operation information is included in the time period indicated by the time period information associated with the operation manager ID specified by the specifying unit 133, the notification unit 134 provides notification of the operation status notification information. By doing so, since the operation status notification information is only transmitted during the time period desired by the manager of the notification destination, the operation plan management device 1 can further reduce the load associated with transmission of the operation status notification information, compared to the case of transmitting operation status notification information regardless of the time period.

In addition, in an emergency such as when a disaster or accident occurs, the notification unit 134 may transmit the operation status notification information to the notification destination corresponding to the operation manager ID specified by the specifying unit 133, regardless of the content of the notification necessity information. In an emergency such as when a disaster or accident occurs, the notification unit 134 may notify, the municipality corresponding to the administrative division corresponding to the flight position of the flight device indicated by the operation information acquired by the operation information acquisition unit 135, of the operation status notification information. In this case, it is assumed that the storage unit 12 stores, as the contact address of the municipality corresponding to each of the plurality of administrative divisions, the mail address of the municipality, etc. In addition, in an emergency such as when a disaster or accident occurs, the notification unit 134 may notify the municipality in the administrative division corresponding to the scheduled operation range of the flight device indicated by the operation plan information acquired by the plan information acquisition unit 131 of the plan notification information.

The case was exemplified of the notification unit 134 transmitting operation status notification information to the notification destination corresponding to the operation manager ID on the condition of the flight device that flew based on the operation plan information having entered the area managed by the operation manager corresponding to the operation manager ID, but the present invention is not limited thereto. The notification unit 134 may provide notification of the operation status notification information on the condition of the flight device that flew based on the operation plan information having entered a specific area designated by the operation manager corresponding to the operation manager ID.

In this case, the storage unit 12 associates and stores the operation manager ID as the notification destination information, and specific area information indicating a specific area in the area managed by the operation manager that requires notification of the operation information to the notification destination corresponding to the operation manager ID. FIG. 7 is a diagram showing an example of notification destination management information including specific area information. In the example shown in FIG. 7, it can be confirmed that specific area information is associated with the operation manager ID as notification destination information, area information, and notification necessity information.

The notification unit 134 provides notification of operation status notification information when the flight position information included in the operation information acquired by the operation information acquisition unit 135 is included in the specific area indicated by the specific area information associated with the operation manager ID specified by the specifying unit 133. For example, the notification unit 134 specifies administrative divisions based on the latitude and longitude indicated by the flight position information included in the operation information acquired by the operation information acquisition unit 135. The notification unit 134 provides notification of the operation status notification information when the specified administrative division indicates the specific area. By doing so, for example, since the operation manager of the notification destination can acquire operation information only relating to a specific area where flight devices are overcrowded among the areas he or she manages, management of the operation of flight devices in the specific area becomes easier to manage.

### [Operation Flow]

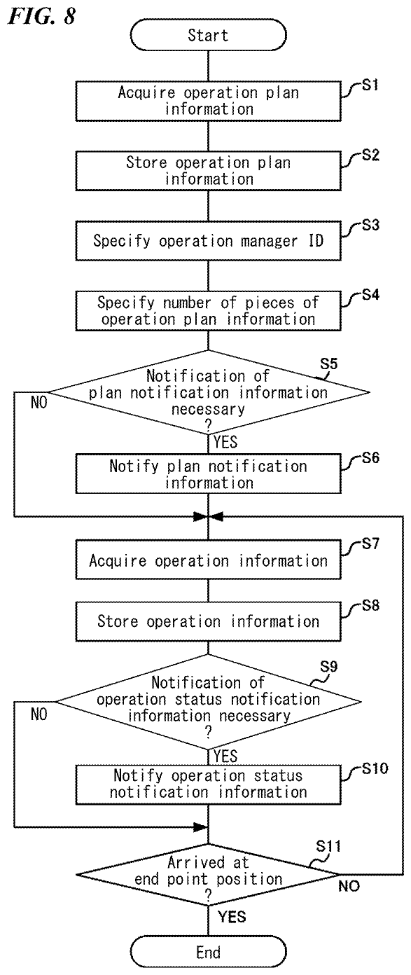

Next, the flow of processing in operation plan management device 1 will be described. FIG. 8 is a flowchart showing the flow of processing in the operation plan management device 1. With reference to FIG. 8, the flow of processing when operation plan information is acquired from the operator terminal 4 will be described. Here, the explanation is based on the assumption that the storage unit 12 stores notification destination management information in which an operation manager ID, area information, and notification necessity information are associated with each other.

First, the plan information acquisition unit 131 acquires operation plan information from the operator terminal 4 (S1). When the plan information acquisition unit 131 acquires the operation plan information from the operator terminal 4, the memory control unit 132 sets the operation manager ID included in the operation plan information to the operation manager ID of the manager of the operation plan management device 1, stores the operation plan information in the storage unit 12 and also stores the operation plan information in the storage unit of the integrated management device 3 (S2).

Then, the specifying unit 133 specifies the operation manager ID as notification destination information stored in the storage unit 12 in association with each of one or more areas at least partially overlapping with the scheduled operation range indicated by the movement range information included in the operation plan information acquired by the plan information acquisition unit 131.

Subsequently, the notification unit 134 specifies the number of pieces of operation plan information managed by the operation manager corresponding to the operation manager ID specified in S3 (S4). On the basis of the number of pieces of operation plan information specified, the notification unit 134 determines whether or not it is necessary to notify the notification destination corresponding to the operation manager ID of the plan notification information, which is at least one of at least partial information included in the operation plan information and first access destination information for accessing the partial information (S5). Upon determining that it is necessary to provide notification of the plan notification information, the notification unit 134 shifts the processing to S6, and notifies the notification destination corresponding to the specified operation manager ID of the plan notification information. When the notification unit 134 determines that it is not necessary to provide notification of the plan notification information, the processing proceeds to S7.

The operation information acquisition unit 135 acquires operation information including the flight device ID corresponding to the flight device and flight position information indicating the current flight position of the flight device from the flight device that flew based on the operation plan information acquired in S1 (S7). The storage control unit 132 causes the storage unit 12 to store the operation information acquired by the operation information acquisition unit 135 (S8).

The notification unit 134 determines whether or not it is necessary to notify the notification destination corresponding to the operation manager ID specified in S3 of operation status notification information, which is at least one of the operation information and second access destination information for accessing the operation information (S9). Upon determining that it is necessary to provide notification of the operation status notification information, the notification unit 134 advances the processing to S10, and notifies the notification destination corresponding to the specified operation manager ID of the operation status notification information. Upon determining that it is not necessary to provide notification of the operation status notification information, the notification unit 134 shifts the processing to S11.

Subsequently, the notification unit 134 determines whether or not the flight device has arrived at the end point position indicated by the operation plan information acquired in S1 based on the operation information acquired in S7 (S11). Upon determining that the flight device has reached the end point position, the notification unit 134 ends the processing according to this flowchart, and if the notification nit 134 determines that the flight device has not reached the end point position, the notification unit 134 shifts the processing to S7.

### [Modification 1]

In the above description, the operation plan management device 1 specified the operation manager ID associated with an area that at least partially overlaps with the scheduled operation range indicated by the movement range information included in the acquired operation plan information, and notified the notification destination corresponding to the operation manager ID of the plan notification information, but the present invention is not limited thereto. For example, the integrated management device 3 may have the plan information acquisition unit 131, the storage control unit 132, the specifying unit 133, and the notification unit 134, and may notify the notification destination corresponding the operation manager ID of the plan notification information.

In this case, the storage unit of the integrated management device 3 stores the operation manager ID as notification destination information indicating the notification destination of the manager who manages flight device operations, and area information indicating the area managed by the manager. The integrated management device 3 acquires the operation plan information from the operation plan management device 1 or the other-company operation plan management device 2. The integrated management device 3 specifies an operation manager ID stored in the storage unit in association with an area that at least partially overlaps with the scheduled operation range indicated by the movement range information included in the acquired operation plan information, and notifies the notification destination corresponding to the operation manager ID of the plan notification information. By doing so, when the integrated management device 3 has a function of notifying the plan notification information, it is possible to provide notification of the plan notification information only to the destinations that require the plan notification information. Thereby, the integrated management device 3 can reduce the load related to notification of the plan notification information.

### [Modification 2]

In the above description, the operation plan management device 1 specified the operation manager ID as notification destination information stored in the storage unit 12 in association with an area that at least partially overlaps with the scheduled operation range indicated by the movement range information included in the acquired operation plan information, and notified the notification destination corresponding to the specified operation manager ID of the plan notification information, but the present invention is not limited thereto. The operation plan management device 1 may specify the operation manager ID without referring to the scheduled operation range indicated by the movement range information included in the acquired operation plan information.

For example, in an area where the operation manager of the operation plan management device 1 manages the operation of the flight device, the storage unit 12 of the operation plan management device 1 stores the operation manager ID as notification destination information indicating the notification destination of another operation manager managing the operation of another flight device not managed by the said operation manager. Then, when the plan information acquisition unit 131 acquires the operation plan information, the notification unit 134 of the operation plan management device 1 notifies the notification destination corresponding to the operation manager ID stored in the storage unit 12 of the plan notification information, which is at least one of at least partial information included in the acquired operation plan information and first access destination information for accessing the partial information. By doing so, the operation plan management device 1 can effectively provide notification of the operation plan information similarly to the case of referring to the scheduled operation range indicating by the movement range information included in the acquired operation plan information to specify notification destination information and notify the notification destination of the plan notification information.

### [Effect of Operation Plan Management Device 1]

As described above, the operation plan management device 1 according to the present embodiment associates and stores notification destination information indicating the notification destination of the operation manager who manages the operation of a flight device, and area information indicating the area managed by the operation manager, and specifies notification destination information associated with the area at least partially overlapping with the scheduled operation range indicated by the movement range information of the flight device included in the acquired operation plan information. The operation plan management device 1 notifies the notification destination indicated by the specified notification destination information of plan notification information, which is at least one of at least partial information included in the operation plan information and first access destination information for accessing that partial information. By doing so, the operation plan management device 1 can efficiently provide notification of the operation plan information.

It should be noted that this embodiment makes it possible to contribute to Goal 9, “Build resilient infrastructure, promote sustainable industrialization, and foster innovation”, of the Sustainable Development Goals (SDGs) led by the United Nations.

As described above, several techniques have been proposed for information processing devices and information processing methods.

Each of the plurality of UASSPs manages operation plans for flight devices that fly in a predetermined area. On the other hand, it would be inefficient for each of a plurality of UASSPs to notify all other UASSPs upon receipt of operation plan information.

At least one exemplary embodiment of the present invention can, for example, exhibit the effect of efficiently providing notification of operation plan information.

While preferred embodiments of the invention have been described and illustrated above, it should be understood that these are exemplary of the invention and are not to be considered as limiting. Additions, omissions, substitutions, and other modifications can be made without departing from the scope of the present invention. For example, all or part of the device can be functionally or physically distributed and integrated in arbitrary units. In addition, new embodiments resulting from arbitrary combinations of multiple embodiments are also included in the present embodiment. Accordingly, the invention is not to be considered as being limited by the foregoing description, and is only limited by the scope of the appended claims.

What is claimed is:

1. An information processing device comprising:
a storage unit that associates and stores notification destination information indicating a notification destination of a manager who manages an operation of a flight device, and area information indicating an area managed by the manager;
a plan information acquisition unit that acquires operation plan information including flight device identification information for identifying a flight device scheduled to fly, scheduled operation date and time information indicating a date and time when the flight device is scheduled to fly, and movement range information indicating a scheduled operation range in which the flight device is scheduled to fly;
a specifying unit that specifies the notification destination information stored in the storage unit in association with the area at least partially overlapping with the scheduled operation range indicated by the movement range information included in the operation plan information acquired by the plan information acquisition unit; and
a notification unit that notifies the notification destination indicated by the notification destination information specified by the specifying unit of plan notification information, which is at least one of at least partial information included in the operation plan information acquired by the plan information acquisition unit and first access destination information for accessing that partial information.

2. The information processing device according to claim 1, further comprising an operation information acquisition unit that acquires operation information including the flight device identification information corresponding to the flight device and flight position information indicating the current flight position of the flight device from the flight device that flew based on the operation plan information acquired by the plan information acquisition unit,
wherein the notification unit notifies the notification destination indicated by the notification destination information specified by the specifying unit of operation status notification information, which is at least one of the operation information acquired by the operation information acquisition unit and second access destination information for accessing the operation information.

3. The information processing device according to claim 2, wherein
the storage unit associates and stores the notification destination information and notification necessity information indicating whether or not notification of the operation information to the notification destination indicated by the notification destination information is required; and
the notification unit provides notification of the operation status notification information when the notification necessity information stored in the storage unit associated with the notification destination information specified by the specifying unit indicates that notification of the operation information is required.

4. The information processing device according to claim 3, wherein
the storage unit associates and stores the notification destination information and time period information indicating a time period in which notification of the operation information to the notification destination indicated by the notification destination information is required; and
the notification unit provides notification of the operation status notification information when the time at which the operation information acquisition unit has acquired the operation information is included in the time period indicated by the time period information stored in the storage unit in association with the notification destination information specified by the specifying unit.

5. The information processing device according to claim 3, wherein
the storage unit associates and stores the notification destination information and specific area information indicating a specific area, included in the area, that requires notification of the operation information to the notification destination indicated by the notification destination information, and
the notification unit provides notification of the operation status notification information when the flight position information included in the operation information acquired by the operation information acquisition unit is included in the specific area indicated by the specific area information associated with the notification destination information specified by the specifying unit.

6. The information processing device according to claim 4, wherein
the storage unit associates and stores the notification destination information and specific area information indicating a specific area, included in the area, that requires notification of the operation information to the notification destination indicated by the notification destination information, and
the notification unit provides notification of the operation status notification information when the flight position information included in the operation information acquired by the operation information acquisition unit is included in the specific area indicated by the specific area information associated with the notification destination information specified by the specifying unit.

7. The information processing device according to claim 1, wherein
the notification unit specifies the number of pieces of the operation plan information managed by the manager corresponding to the notification destination information specified by the specifying unit, determines whether to provide notification of the plan notification information on the basis of the number of number of pieces of operation plan information specified, and provides notification of the plan notification information upon determining to provide notification of the plan notification information.

8. The information processing device according to claim 7, wherein
the notification unit determines whether or not to provide notification of the plan notification information on the basis of the number of pieces of the operation plan information of another flight device scheduled to fly at the time when the flight device indicated by the operation plan information acquired by the plan information acquisition unit is scheduled to fly, the operation plan information being managed by the manager corresponding to the notification destination information specified by the specifying unit.

9. The information processing device according to claim 1, wherein
the notification unit notifies the notification destination indicated by the notification destination information specified by the specifying unit of the plan notification information including at least one of the movement range information including the area corresponding to the notification destination and an area different from that area, included in the operation plan information acquired by the plan information acquisition unit, and the first access destination information for accessing the movement range information.

10. The information processing device according to claim 1, wherein
the specifying unit specifies a plurality of the pieces of notification destination information stored in the storage unit in association with a plurality of the areas at least partially overlapping with the scheduled operation range indicated by the movement range information included in the operation plan information acquired by the plan information acquisition unit; and
the notification unit notifies the plurality of notification destinations indicated by each of the plurality of pieces of notification destination information specified by the specifying unit of the plan notification information.

11. The information processing device according to claim 1, wherein
the specifying unit specifies one or more pieces of notification destination information stored in the storage unit in association with the area at least partially overlapping with the scheduled operation range indicated by the movement range information included in the operation plan information acquired by the plan information acquisition unit; and
the notification unit notifies the notification destination indicated by each of the plurality of pieces of the plan notification information when the specifying unit has specified a plurality of pieces of the notification destination information.

12. An information processing device used by a manager who manages an operation of a flight device, the information processing device comprising:
a storage unit that stores notification destination information indicating a notification destination of another manager who manages the operation of another flight device not managed by the manager in an area in which the manager manages the operation of the flight device;
a plan information acquisition unit that acquires operation plan information indicating an operation plan to be managed by the manager, which is the operation plan of the flight device scheduled to fly in the area; and
a notification unit that, when the plan information acquisition unit acquires operation plan information, notifies the notification destination indicated by the notification destination information stored in the storage unit of plan notification information, which is at least one of at least partial information included in the operation plan information acquired by the plan information acquisition unit and first access destination information for accessing that partial information.

13. An information processing method, executed by a computer, the information processing method comprising:
acquiring operation plan information including flight device identification information for identifying a flight device scheduled to fly, scheduled operation date and time information indicating a date and time when the flight device is scheduled to fly, and movement range information indicating a scheduled operation range in which the flight device is scheduled to fly;
referring to a storage unit that associates and stores notification destination information indicating a notification destination of a manager who manages an operation of the flight device and area information indicating an area managed by the manager to specify the notification destination information associated with the area at least partially overlapping with the scheduled operation range indicated by the movement range information included in the acquired operation plan information; and
notifying the notification destination indicated by the specified notification destination information of plan notification information, which is at least one of at least partial information included in the acquired operation plan information and first access destination information for accessing that partial information.
